(19) United States
(12) Patent Application Publication
(10) Pub. No.: US 2002/0138406 A1
(43) Pub. Date: Sep. 26, 2002

(54) Method and apparatus to identify future events and develop an action plan to address the impact of those events on current design viability

(76) Inventor: Abdel Kader Elgabry, Brookfield, WI (US)

Correspondence Address: COOK & FRANKE S.C. (GEMS), 660 EAST MASON STREET, MILWAUKEE, WI, 53202, US

(21) Appl. No.: 09/681,347

(22) Filed: Mar. 22, 2001

(51) Int. Cl. G06F 17/60

(52) U.S. Cl. 705/38

(57) ABSTRACT

The present invention is directed to a method and apparatus to identify future events and develop an action plan to address the impact of those events on current design viability. The present invention includes a method to assess the impact of those future changes by isolating a period of criticality for a current model and identifying a number of impacting change factors of the isolated period of criticality. The method also includes the step of determining a risk assessment value for each of the number of impacting change factors and prioritizing the number of impacting change factors based on each risk assessment value so that a directed action plan may be formulated for each of the impacting change factors based on their respective risk assessment value. A computer program is provided for an automated risk assessment tool identifying future events and minimizing risks associated with the future events.

### BACKGROUND OF THE INVENTION

The present invention relates generally to risk assessment and, more specifically, to a method and apparatus to identify future events having an impact on viability of a current design model and to develop an action plan to address the impact of those events.

Typically, before a company introduces a new product to the marketplace, the product is subjected to a risk assessment evaluation. That is, before launching the product and making it available to consumers, the company first determines the risks associated with introducing the product. In fact, most companies implement a risk assessment tool from product conception to the time of product introduction to the marketplace. By utilizing an ongoing risk assessment system, the company is able to adjust design of the product to address various risks.

For example, risk assessment may reveal that a particular component or part of a proposed product is subject to unusual wear and tear thereby requiring redesign of that product. The risk assessment evaluation might also reveal that present product configuration is susceptible to misuse by a consumer. As a result, the company may elect to redesign the proposed product to protect against the misuse or decide that placing an appropriate warning label is sufficient.

These known risk assessment tools assist a company in evaluating potential failures for a proposed system design or manufacturing process. These known tools further provide risk assessment by identifying and determining the criticality and impact of the potential failures on the proposed product, system, or manufacturing process. These known tools, however, fail to identify, prioritize, and address risks associated with rapid changes in the marketplace that may affect the future viability of the proposed system, process, or product.

In a complex and ever-changing marketplace, customer's needs and/or expectations may change quickly in response to changes in the marketplace. Since the customer's needs and expectations change quickly, it is not feasible for a particular company to alter a particular system, process, or product once it has been introduced to the marketplace. Redesigning a particular product to address a new customer need can be a time-consuming and costly endeavor and, moreover, the customer may have new needs and/or expectations that arise before the redesign is complete. The difficulty in redesigning a product to satisfy new needs of a particular customer are exaggerated by the unexpected changes in supply, resources, and business necessities associated with Internet-based e-commerce.

It would therefore be desirable to design a risk assessment tool to effectively identify and determine the impact of future events on the future success of a product prior to implementation and/or introduction of the product to the marketplace.

### SUMMARY OF INVENTION

A method and apparatus to identify, assess, and address the impact of future changes on a current model overcoming the aforementioned drawbacks are provided.

In accordance with one aspect of the present invention, a method to assess the impact of future changes on a current model includes the step of isolating a period of criticality for a current model. The method further includes the step of identifying a number of impacting change factors of the period of criticality as well as determining a risk assessment value for each of the number of impacting change factors. The method further includes the step of prioritizing the number of impacting change factors based upon each risk assessment value thereby enabling the formation of an action plan to address the impacting change factors in-turn based on a factor's impact on the viability of the current model.

In another embodiment of the present invention, a method to address foreseeable risks comprises the step of identifying a number of foreseeable risks for a critical time window and determining an impact for each foreseeable risk to the viability of a proposed implementation. The method also includes the step of developing an action plan to negate the impact of each foreseeable risk to the viability of the proposed implementation as well as minimizing the impact of each foreseeable risk in accordance with the action plan. The method also includes the step of re-determining the impact of each foreseeable risk after a completion of the step of minimizing the impact of each foreseeable risk.

The present invention further contemplates an automated, computer-based risk assessment tool. Therefore, in accordance with another aspect of the invention, a computer program to determine an impact of a foreseeable event on a present design is provided. The computer program includes a set of instructions that when executed by a one or more computers causes the one or more computers to identify a plurality of foreseeable events each having an effect on future viability of a present design and determine a severity factor for each of the foreseeable events. The set of instructions further causes the one or more computers to determine a probability or likelihood of occurrence factor for each foreseeable event as well as determine a detectability or likelihood of detection factor for each foreseeable event. The set of instructions also causes the one or more computers, based on the determined severity, probability, and detectability factors, to determine a change risk prioritization number for each foreseeable event.

Various other features, objects and advantages of the present invention will be made apparent from the following detailed description and the drawings.

### BRIEF DESCRIPTION OF DRAWINGS

The drawings illustrate one preferred embodiment presently contemplated for carrying out the invention. In the drawings:

FIG. 1 is a representation of a tabular document for identifying and assessing the impact of future events on a present product design in accordance with the present invention.

FIG. 2 is a representation of a tabular document to assist in assigning a severity of an effect value to a future event in accordance with the present invention.

FIG. 3 is a representation of a tabular document implemented with the present invention to assist in assigning a likelihood of detection value for a future event in accordance with the present invention.

FIG. 4 is a flow chart illustrating the steps of a method and the acts of a computer program to identify and assess the impact of future events on a current product design in accordance with the present invention.

### DETAILED DESCRIPTION

The present invention is directed to a method and apparatus to identify a number of foreseeable events that will have an impact on the viability of a proposed product, system, or process and to develop an action plan to redress the impact of these events.

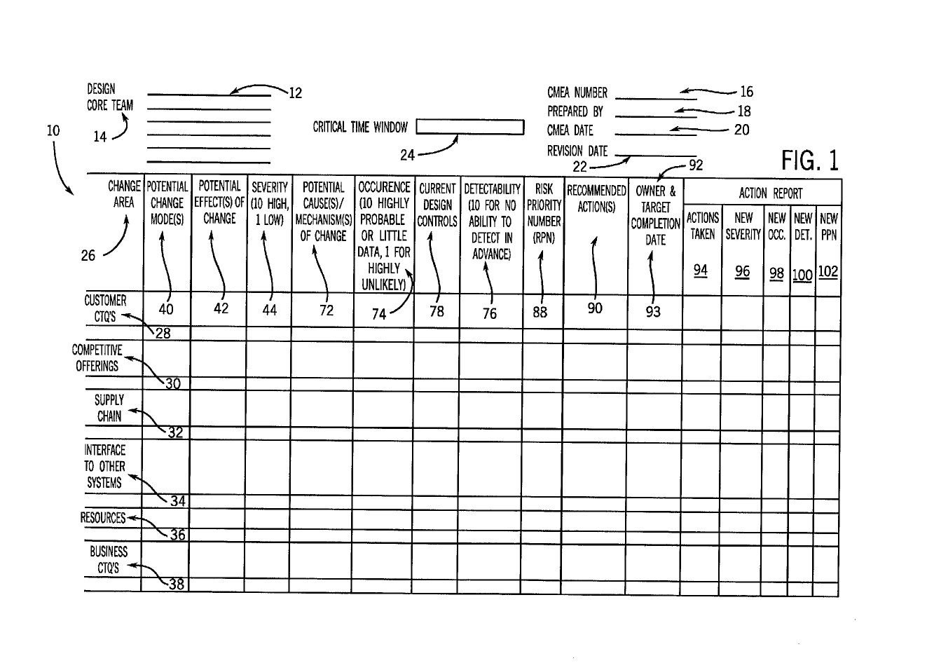

Referring to FIG. 1, a representation of a spreadsheet document 10 is shown in accordance with the present invention. It should be noted that the present invention contemplates implementation of the present invention in a paper-dependent as well as computer-dependent environment. That is, the present invention envisions spreadsheet 10 in a paper document form as well as an electronic graphical form displayed on a monitor of a computer-based system. The present invention further contemplates that spreadsheet 10 may be created using any document creation software applications including spreadsheet creation applications such as Microsoft® Excel, and Lotus® 1-2-3, as well as, other various electronic document management systems.

Still referring to FIG. 1, spreadsheet 10 is preferably arranged in a columnar format wherein the information to be input on the spreadsheet 10 may be efficiently organized and analyzed. Spreadsheet 10 includes a number of product identifiers including a design identifier 12 as well as a list of the individuals involved in the particular design forming a design team 14. Spreadsheet 10 further includes a design number identifier 16, an author identifier 18, a date identifier 20, as well as, a revision date 22, if applicable.

Spreadsheet 10 also includes a critical time window identifier 24. Critical time window 24 indicates a time range that the risk assessment analysis (to be discussed shortly) will apply. That is, the present invention envisions that future events affecting a particular product and/or its design may vary as to when the events may affect or impact the proposed product or design. By limiting a particular risk analysis to a specific critical time window 24, the present invention allows a design team 14 to direct their efforts to minimize or reduce the risks to the proposed design 12 for a defined and limited period of time. Limiting a team's 14 focus to a limited time period helps focus a team's efforts as well as helps to generate a more efficient action plan to address the risks pertaining to the proposed design 12.

As shown in FIG. 1, spreadsheet 10 categorizes potential risks or events into a number of change area categories 26. In one embodiment, the change area categories 26 include consumer Critical-to-Quality concerns (CTQs) 28, competitive offerings 30, supply chain 32, interface to other systems 34, resources 36, and business CTQs 38. The change area categories 28-38 are only representative of a number of categories of which foreseeable events that may affect a particular design may be grouped. However, the listed change area categories 28-38 are particularly representative of concerns often associated with e-commerce or e-business design plans. One of ordinary skill in the art will appreciate, however, that additional change area categories may be identified that are more pertinent to a particular design or product implementation.

Each change area category 28-38 is representative of a number of potential change modes 40 or change events that may affect the proposed design 12. The number of potential change modes are only limited to the foretelling skills of the design team 14. That is, any potential change mode that may be reasonably foreseen may be categorized to a particular change area category 28-38 and, as will be discussed shortly, evaluated to determine its risk to the proposed design and/or product implementation. Corresponding to each potential change mode 40 the design team 14 identifies an associated potential effect of change 42 as a result of the potential change mode 40. The present invention is not limited to a particular method or system to identify potential change modes 40 or the effects of the potential change modes 42. Identification of the potential change mode 40 and its effect 42 is limited to the skills and experience of the team 14 conducting the risk assessment evaluation.

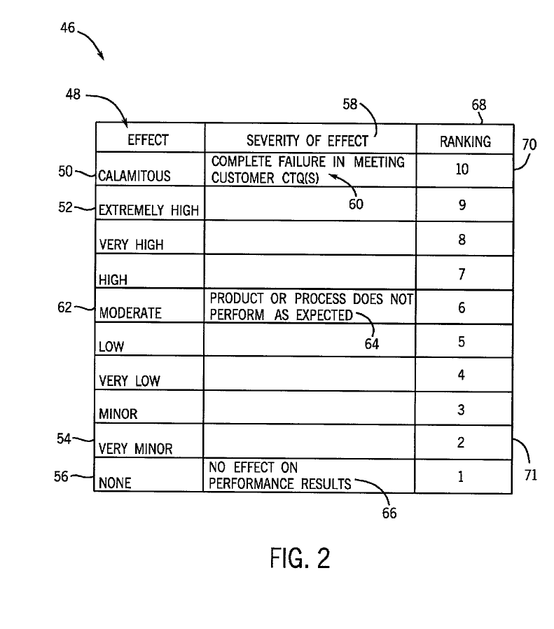

To provide a uniform value to represent the potential effect 42 of the potential change mode 40, the present invention contemplates a severity factor 44 being assigned to each identified change mode 40, with a value of 10 being the highest and a value of 1 being the lowest in severity. To assist the design team 14 in determining the severity factor 44, the present invention contemplates a severity table 46 as illustrated in FIG. 2. Shown in FIG. 2 and in a tabular format, spreadsheet 46 identifies a number of effects 48 ranging from calamitous and extremely high 50, 52 to very minor and none 54, 56. Corresponding to each effect 48 is a definitional summary of the severity of effect 58. For example, a calamitous effect would be described as a “complete failure in meeting customer CTQs” 60. A moderate effect 62, however, may be defined by “product or process does not perform as expected” 64, whereas a “none” effect 56 would indicate that the potential change mode has “no effect on performance results” 66. In a preferred embodiment,.a calamitous effect 50 is an assigned a severity factor value of 10 in window 70. Whereas, a very minor effect 54 would be assigned a severity factor value of 2 in window 71.

Referring again to FIG. 1, severity factor 44 is only one factor to be considered by the design team or risk assessment team in determining a potential change mode's 40 impact on the proposed design or product implementation 12. The present invention further contemplates the identification of a potential cause and/or mechanism of change 72 responsible for the identified change mode 40. For instance, the potential cause 72 for a delay or non-shipment of products might include a work stoppage resulting from a labor strike. To properly assess the impact of the potential cause and/or mechanism of change 72, the present invention includes the assignment of a probability factor 74 to the potential cause 72. The probability factor 74 is an indication of the design team's estimated determination of the likelihood that the particular cause 72 will, in fact, occur. A large value assigned to the probability factor 74 represents the design team's belief that the potential cause or mechanism of change will most likely occur. Conversely, a low probability factor is indicative of the team's doubt that the potential cause or mechanism of change will occur. The value can change from 10 for highly probable to 1 for highly unlikely.

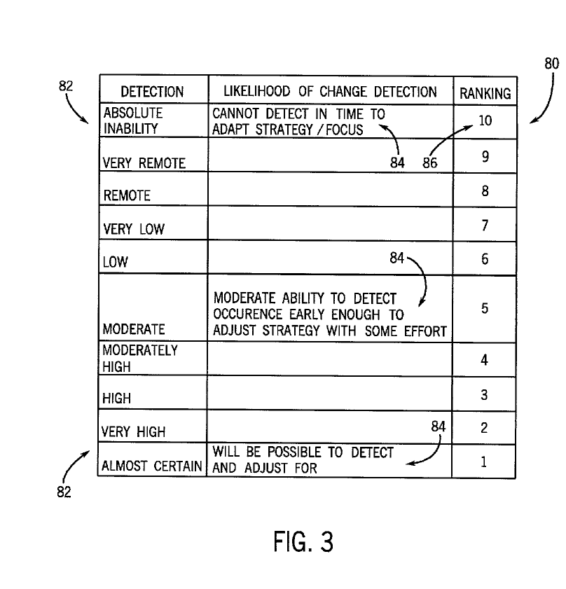

Still referring to FIG. 1, the present invention further contemplates a detectability factor 76. The detectability factor represents a company's ability to detect, and adapt and/or adopt a new strategy or focus to combat the effect of the identified change mode 40. Preferably, a detectability factor with a value of 10 represents a total or absolute inability to detect or adapt a new strategy or focus in time to meet a consumer or client's needs or expectations. Conversely, a detectability factor having a value of 1 indicates that detection is almost certain and it will be possible for the company to detect and adjust for the change mode 40. Corresponding to each potential change mode 40, the design team 14 identifies one or more current design controls 78 that are responsible for detecting the potential change modes or events. A tabular detection chart 80, FIG. 3, includes a detection status identifier 82 and a corresponding detection status definition 84. As further illustrated in FIG. 3, chart 80 ranks each detection status 82 with a corresponding ranking value 86.

Referring back to FIG. 1, to determine the overall impact of a potential change mode 40 on a proposed product or implementation 12 the present invention contemplates a change risk priority number (RPN) 88 for each potential change mode 40. The RPN 88 in a preferred embodiment is the multiplication of the severity factor 44, the probability factor 74, and the detectability factor 76. The maximum RPN that may be assigned to a particular change mode 40 is a value of 1000 whereas the lowest value that may be assigned is a value of 1. By determining that a particular change mode 40 has a high RPN 88, the design team 14 can readily identify the change mode 40 having the most substantial and significant impact on the viability of the proposed product or process implementation 12. In response to each change mode 40, the design team 14 develops a recommended action plan 90. The action plan 90 is the design team's 14 plan of attack to minimize or negate the effect 42 of a potential change mode 40.

Spreadsheet 10 further includes an owner and target date designation 92 for each potential change mode or event 40. The identified owner 92 may include members of the design team 14 or other individuals, such as marketing directors, web developers, and engineers within the company. The target completion date 92 should allow sufficient time for the identified owner 92 to carry out the recommended actions 90 to eliminate or, at a minimum, address the potential effects 42 of the foreseeable event 40.

At periodic intervals or after implementation of the action plan, a new severity value 96, a new occurrence value 98, and a new detectability value 100 are determined for the identified event 40 and are used to determine a new RPN 102. The new RPN 102 provides an indication to the design team 14 on whether the actions taken 74 to combat the effects 42 of the identified event 40 were successful in reducing and/or eliminating the impact associated with the foreseeable event 40. Based on the new RPN 102, the design team 14 may recommend a new or amended action plan to readdress the potential change mode 40. Preferably, the evaluating and addressing iterations repeat until each identified change mode 40 has a final low value RPN. However, the present invention contemplates an RPN threshold chosen by the design team 14 or mandated by company guidelines to determine those change modes 40 that have an acceptable RPN value.

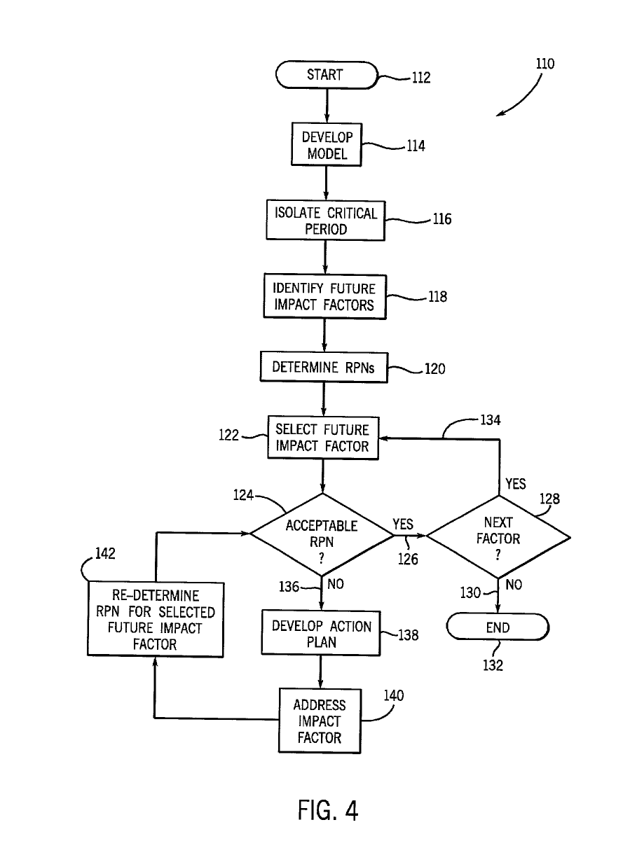

Accordingly, the present invention contemplates a method and computer program to identify future events and develop an action plan to address the impact of those events on current design viability. Referring to FIG. 4, the algorithm 110 begins at 112 with product or process conception. A model or design is developed at 114 to implement the conceived product or process. The developed model 114 may be focused to bring a particular product to the marketplace or introduce a new process within a proprietary manufacturing facility. In accordance with the present invention, risk assessment begins by isolating a period of criticality 116. As indicated previously, the period of criticality 116 helps narrow the focus and efforts of the design team to identify and assess the impact of future events on the proposed product or process implementation. At 118, the design team identifies a number of future impact factors or foreseeable events that may have an impact on the proposed product or process. The identified impact factors should properly reflect the myriad of events that may effect the ongoing success of the proposed product once it has been introduced to the marketplace. That is, the identified impact factors should include events that may effect a potential or existing consumer's needs and expectations relating to the product.

Once the future impact factors have been identified at 118, the design team determines a risk prioritization number 120 for each identified impact factor. As indicated previously, the RPN ranges from a value of 3 to a maximum value of 130 and represents the overall impact a particular factor may have on the ongoing viability of the proposed product 114. In one embodiment, the RPN consists of three components, namely, a severity factor, a probability factor, and a detectability factor. To achieve an RPN, the severity factor, probability factor, and the detectability factor are multiplied.

After determining an RPN for each identified impact factor at 120 the impact factor having the highest RPN, which is indicative of the most substantial risk to the proposed product, is selected at 122 and, in a preferred embodiment, compared to an RPN threshold value. That is, a design team or some other unit in the company may determine that an RPN value, for example, of 50 is an acceptable level of risk and, therefore, an action plan to address that impact is not necessary. If the selected impact factor has an acceptable RPN 124, 126, a determination is made to determine the presence of another impact factor at 128. If there are no additional factors to consider 130 the method terminates at 132. If there are additional factors to consider 128, 134, the next impact factor corresponding to the highest remaining RPN is identified and selected at 122.

If a selected impact factor has an unacceptable RPN as determined at 124, 136 the design team develops an action plan to address the impact factor 138. The goal of the design team is to develop a plan to minimize or negate the effect of the selected impact factor on the future viability of the proposed product or implementation. After developing an action plan at 138 and addressing the impact factor in accordance with the developed action plan at 140, the RPN for the selected impact factor is re-determined at 142 to determine the success of the action plan in addressing the impact factor. Once the new RPN is determined at 142, it is compared to the RPN threshold value at 124 to determine if the impact factor exceeds the design team's threshold or the company's mandated guidelines. If not 136, a new action plan is developed at 138 until an acceptable RPN is determined 124, 126. Once the impact factor has been properly addressed and an acceptable RPN has been determined 124, 126, the method continues at 128 by determining the presence of another factor and, if necessary, evaluating the impact of the new impact factor as was heretofore discussed.

The present invention also contemplates an automated computer-based risk assessment tool. Therefore, a computer program having a set of instructions is provided to carry out the steps of method 110, FIG. 4. The computer program is designed to determine an effect of a foreseeable event on a present design and includes a set of instructions that when executed by one or more computers causes the one or more computers to identify a plurality of foreseeable events wherein each event has an impact on the present design. The set of instructions further causes the one or more computers to determine several factors associated with the future event including a severity factor, a probability factor, and a detectability factor. Upon execution of the set of instructions, the one or more computers determines, based on the aforementioned factors, a risk prioritization number (RPN) for each foreseeable event.

A high RPN provides an indication that the corresponding foreseeable event has a substantial and significant impact on the proposed design, system, process, or product. The computer program represented by the set of instructions further causes the one or more computers to identify an individual responsible for addressing the foreseeable event and to define an address ability date for the event. The address ability date is indicative and represents a target date for addressing the impact of the foreseeable event on the present design and may be automatically determined by the one or more computers in accordance with company guidelines. For example, a company may require that a business CTQ event be addressed within 90 days whereas a supply event may require a 14-day target date.

The set of instructions further causes the one or more computers to determine an RPN threshold index value consistent with guidelines provided by the design team responsible for the proposed product. The one or more computers may determine the RPN threshold index values by considering various threshold recommendations.

The present invention is directed to a method and apparatus to identify future events and to develop an action plan to address the impact of those events on current product viability. The present invention includes a method to assess the impact of those future changes by isolating a period of criticality for a current model and identifying a number of impacting change factors of the isolated period of criticality. The method also includes the step of determining a risk assessment value for each of the number of impacting change factors and prioritizing the number of impacting change factors based on each risk assessment value so that a directed action plan may be formulated for each of the impacting change factors based on their respective risk assessment value.

In another embodiment of the present invention, a method to address foreseeable risks includes the step of identifying a number of foreseeable events pertaining to a critical time window. After the number of foreseeable risks are identified, an impact of each foreseeable risk is determined. Once the impact of each foreseeable risk is determined, an action plan is developed to negate the impact of the foreseeable risk to the viability of the implementation such that the impact may be minimized or, preferably, negated. Once the developed action plan has been implemented the impact of each foreseeable risk is re-evaluated to determine if the implemented action plan reduced or negated the impact of the foreseeable risk on the viability of the proposed implementation.

The present invention has been described in terms of the preferred embodiment, and it is recognized that equivalents, alternatives, and modifications, aside from those expressly stated, are possible and within the scope of the appending claims.

1. A method to assess impact of future changes on a current model comprising the steps of:
(A) isolating a period of criticality for a current model;
(B) identifying a number of impacting change factors of the period of criticality;
(C) determining a risk assessment value for each of the number of impacting change factors; and
(D) prioritizing the number of impacting change factors based upon each risk assessment value.

2. The method of claim 1 further comprising the step of periodically evaluating the risk assessment value for each of the number of impacting change factors and re-prioritizing the number of impacting change factors based on the periodic evaluation of the risk assessment values.

3. The method of claim 1 further comprising the step of developing an action plan configured to either one of minimizing or eliminating an effect of an impacting change factor on the current model.

4. The method of claim 3 further comprising the step of assigning a projected target date for either minimizing or eliminating an effect of an impacting change factor on the current model.

5. The method of claim 1 wherein the step of prioritizing the number of impacting change factors based upon each risk assessment value further comprises the step of ranking the number of impacting change factors in a descending arrangement based upon the risk assessment values and further comprising the step of addressing the number of impacting change factors in turn based upon the descending arrangement.

6. The method of claim 5 further comprising the step of repeating steps (C) and (D) of claim 1 after the number of impacting change factors have been addressed.

7. The method of claim 1 wherein the step of determining a risk assessment value for each of the number of impacting change factors includes the steps of:
determining a severity value for each impacting change factor;
estimating a likelihood of occurrence for each impacting change factor; and determining a detectability coefficient for each impacting change factor.

8. The method of claim 7 further comprising the step of summing the severity value, the likelihood of occurrence, and the detectability coefficient for an impacting change factor to derive the risk assessment value for the impacting change factor.

9. The method of claim 1 further comprising the step of eliminating a need to redesign the current model after implementation of the current model.

10. A method to address foreseeable change risks comprising the steps of:
(A) identifying a number of foreseeable risks for a critical time window;
(B) determining an impact of each foreseeable risk for viability of a proposed implementation;
(C) developing an action plan to negate the impact of each foreseeable risk to the viability of the proposed implementation;
(D) minimizing the impact of each foreseeable risk in accordance with the action plan; and
(E) re-determining the impact of each foreseeable risk after completion of the step of minimizing the impact of each foreseeable risk.

11. The method of claim 10 wherein the step of determining an impact further comprises the step of determining a change risk prioritization number (RPN).

12. The method of claim 11 further comprising the step of multiplying a severity factor, a probability factor, and a detectability factor.

13. The method of claim 11 further comprising the step of determining a foreseeable change risk having the highest RPN and organizing each additional foreseeable change risk in descending order based on the RPN corresponding to each additional foreseeable change risk.

14. The method of claim 10 further comprising the step of repeating steps (B)-(E) until an acceptable RPN for each foreseeable change risk has been obtained.

15. The method of claim 14 further comprising the step of executing the proposed implementation once an acceptable RPN for each foreseeable change risk has been obtained.

16. A computer program to determine an effect of a foreseeable event on a present design having a set of instructions that when executed by one or more computers causes the one or more computers to:
identify a plurality of foreseeable events each having an effect on a present design;
determine a severity factor for each foreseeable event;
determine a probability factor for each foreseeable event;
determine a detectability factor for each foreseeable event; and
determine a risk prioritization number (RPN) for each foreseeable event.

17. The computer program of claim 16 wherein the set of instructions further causes the one or more computers to rank each RPN from a high change risk state to a low change risk state for the plurality of foreseeable events.

18. The computer program of claim 17 wherein the foreseeable event with the highest risk state represents the foreseeable event posing a most significant change risk to present design success.

19. The computer program of claim 16 wherein the RPN for each foreseeable event is a multiplication of the severity factor, probability factor, and detectability factor.

20. The computer program of claim 1 6 wherein the set of instructions further causes the one or more computers to identify an individual responsible for addressing a foreseeable event and further causes the one or more computers to identify an addressability date for each foreseeable event, wherein the addressability date represents a target date for amending the present design to negate the effect of the foreseeable event on the present design.

21. The computer program of claim 16 wherein the computer program further causes the one or more computer to determine the RPN for each foreseeable event for a critical time window.

22. The computer program of claim 16 wherein the plurality of foreseeable events are selectable from a number of event categories including competitive offerings, supply chain, interface to other systems, resources, customer critical-to-quality (CTQ) issues, and business CTQ issues.

23. The computer program of claim 16 wherein the computer program further causes the one or more computers to determine an RPN threshold index and further causes the one or more computers to identify the future events having an RPN greater than the RPN threshold index.
